(19) United States
(12) Patent Application Publication
(10) Pub. No.: US 2010/0291529 A1
(43) Pub. Date: Nov. 18, 2010

(54) TECHNIQUES FOR COMPETITIVE EDUCATION

(76) Inventors: Stephen R. Carter, Spanish Fork, UT (US); Jeanne Noelle Carter, Lyman, WY (US); Stephen Ruben Carter, Lyman, WY (US)

Correspondence Address: SCHWEGMAN, LUNDBERG & WOESSNER/NOVELL, PO BOX 2938, MINNEAPOLIS, MN, 55402, US

(21) Appl. No.: 12/467,418

(22) Filed: May 18, 2009

(51) Int. Cl. G09B 7/00; A63F 9/24

(52) U.S. Cl. 434/362; 463/42

(57) ABSTRACT

Techniques for competitive education are provided. Proficiency-based tasks are administered to participants. Performance on the tasks results in rewards. The rewards are usable as game attributes by the participants in network-based games to affect game play. The network-based games are played as competitions or collaborations among virtual communities.

### BACKGROUND

With the advent of high-bandwidth networking and the maturation of digital identity infrastructures, it is becoming increasingly desirable and possible to conduct methods of educating students and evaluating their learning proficiencies in an environment that does not require traditional school settings. Education “In The Cloud” (EdITC) presents a new set of issues that must be overcome in order to encourage students to learn.

According to some studies in education, students are most involved in learning when that learning is directly applicable to real-life situations. Unfortunately, because students are not yet at the age of majority, school organizations are required to insulate students from real-life situations to prevent the students from harming others and to prevent the students from being harmed in some manner physically, financially, socially, etc. This limitation restricts the pedagogical choices available to educators. Therefore, academics could benefit from a virtual “real life” situation that can engage students in terms that have significance for the students and their lives.

Students frequently participate in sports without parental or state mandates. The students participate in sports because of the gratification of competing in the “game.” In volleyball, for example, a player will work toward mastery of a learning target such as bumping, setting, or spiking. The motivation for completing the numerous hours of practice needed for mastery is the anticipation of participating in a game where the player's gained proficiency will be rewarded by the roar of the crowd, the admiration from peers, and ultimately, victory.

Currently no such “game” motivates students to put in the requisite time and practice to achieve academic mastery. Academic assessments, ranging from low-stakes pop quizzes to high-stakes state testing, do not carry the same social cachet that a sporting event carries for students and their communities.

Just as students voluntarily participate in sports, they also voluntarily spend many hours practicing mastery at video games; students should also be as actively involved in academics as they are in sports and video games.

Thus what are needed are improved techniques for collaborative and competitive education.

### SUMMARY

In various embodiments, techniques for competitive education are presented. More specifically, and in an embodiment, a method for collaborative and competitive education is provided. An assessment is received from an authorizing entity that administers the assessment. The assessment is configured by stipulations at least some of which identify rewards that are to be given to participants that take a proficiency-based task associated with the assessment. The rewards are used in the performance of network-based games associated with competitions and collaborations among virtual communities. The rewards are administered to the participants in response to policy enforced during the assessment and as attested to by the authorizing entity or another authorized entity.

### BRIEF DESCRIPTION OF THE DRAWINGS

FIG. 1 is a diagram of a method for collaborative and competitive education, according to an example embodiment.

FIG. 2 is a diagram of another method for collaborative and competitive education, according to an example embodiment.

FIG. 3 is a diagram of a collaborative and competitive education system, according to an example embodiment.

FIG. 4 is a diagram of another collaborative and competitive education system, according to an example embodiment.

FIG. 5 is an example architecture for collaborative and competitive education.

### DETAILED DESCRIPTION

A “resource” includes a user, service, system, device, directory, data store, user, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “agent” may be viewed as a true persona of principal. That is, an agent is a primary identity for a principal, such that the agent is permitted to manage the other identities that may be associated with principal and create new identities for the agent. Any particular assumed identity for an agent is dependent upon contexts and perhaps directions of the agent.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc. As more and more identifiers are accumulated, a confidence in a particular identity grows stronger and stronger. “Confidence” can be enumerated as a value that policy defines, such that as identifiers are accumulated various numeric increments occur to the confidence value and when the confidence value exceeds a given threshold, a particular identity can be assumed and assigned.

A “semantic identity” is a special type of identity that the agent can assume. Automated resources, such as services, may process the semantic identity over a network on behalf of the agent to which the semantic identity is associated. The semantic identity is confined or circumscribed to defined categories and interests identified by the agent. That is, the services that process the semantic identity over a network operate within a circumscribed semantic space of that network, where the semantic space is defined by the categories and the interests of the semantic identity.

In some cases, the semantic services may also automatically update, modify, delete, and/or add to the categories and/or interests, which are associated with the semantic identity. The services of the semantic identity use the semantic identity for mining the network within semantic identity's defined semantic space for purposes of identifying related information and/or relationships that comport with the defined categories and interests of the semantic identity. In some cases, the agent may also manually process transactions over the network as the semantic identity without the benefit of the automated semantic services.

In an embodiment, the true persona of the agent and the other identities of the agent, including the semantic identity and the true persona of the agent, may be created and managed by an identity service. Examples of some identity services, which may be modified with the teachings presented herein, may be found in U.S. Ser. No. 10/765,523, entitled “Techniques for Dynamically Establishing and Managing Authentication and Trust Relationships,” filed Jan. 27, 2004; U.S. Ser. No. 10/767,884, entitled “Techniques for Establishing and Managing a Distributed Credential Store,” filed Jan. 29, 2004; and U.S. Ser. No. 10/770,677, entitled “Techniques for Dynamically Establishing and Managing Trust Relationships,” filed on Feb. 3, 2004. The disclosures of which are incorporated by reference herein.

Various embodiments of this invention can be implemented in existing network architectures. For example, in some embodiments, the techniques presented herein are implemented in whole or in part in the Novell® network and proxy server products, distributed by Novell®, Inc., of Provo, Utah.

Also, the techniques presented herein are implemented in machines, such as processor or processor-enabled devices. These machines are configured to specifically perform the processing of the methods and systems presented herein. Moreover, the methods and systems are implemented in computer-readable storage media and processed on the machines configured to perform the methods.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

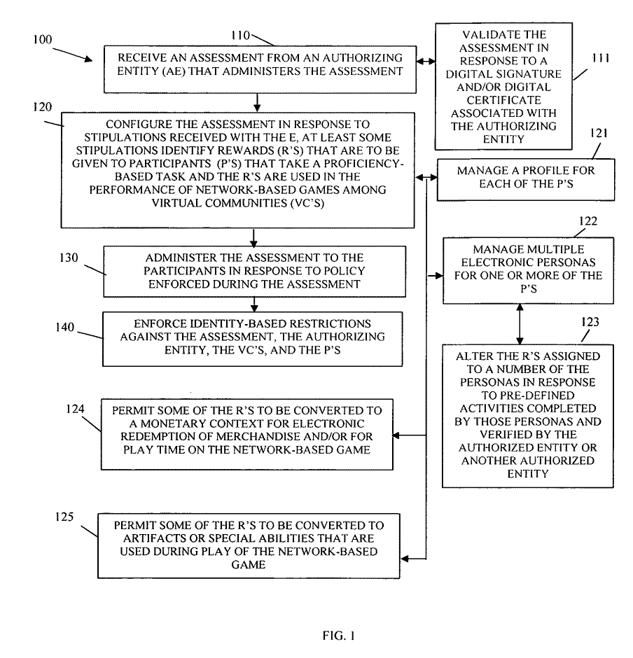

It is within this context that embodiments of the invention are now discussed within the context of FIGS. 1c5.

FIG. 1 is a diagram of a method 100 for collaborative and competitive education, according to an example embodiment. The method 100 (hereinafter “education service”) is implemented in a machine-accessible and computer-readable medium and instructions that execute on a processor (machine, computer, processor, etc.). The machine is specifically configured to process the education service. Furthermore, the education service is operational over and processes within a network. The network may be wired, wireless, or a combination of wired and wireless.

At 110, the education service receives an assessment from an authorizing entity. The authorizing entity is a type of resource, such as a principal. In an embodiment, the authorizing entity is a federal, state, or local government agency, or other form of educational certification and testing authority. In some cases, the authorizing entity may be an automated agent that acts on behalf of the testing agency that administers a proficiency evaluation.

An “assessment” as used herein includes a variety of information that is represented in a data structure and can be administered to students or participants. The data structure is capable of being dynamically evaluated and processed in an automated manner in some instances and in another embodiment can be printed off (or viewed on a display monitor of a computer) and then evaluated by a teacher/leader and reported in an automated computer-based manner. The assessment includes a defined educational subject area for which proficiency of a student/participant is to be judged. The assessment also includes mechanisms (guidelines, policies, and/or rules) for evaluating the formative and/or summative proficiencies of a student or participant in that defined educational subject area. The assessment also includes procedures for administering one or more proficiency-based tasks in the defined educational subject area. This is a proficiency task to be given in the defined educational subject area. The content of the proficiency-based task is also provided in the assessment. Moreover, the assessment includes rewards (e.g., ratings and/or scores, etc.) that are to be given based on responses to the content of the proficiency-based task in the defined educational subject area. Some proficiency-based tasks are entirely automated and can be processed on a computer or processor-enabled device; some are manually administered; and some involve a series of activities that a student/participant needs to be evaluated on, such as but not limited to, home work, lab work, quizzes, community service, and the like. An indication as to whether the student/participant proficiency-based task can be given in just one way or in a variety of ways discussed above can also be included in the assessment. Moreover, when a proficiency-based task is not done via a computer and in an automated manner, the results of the proficiency-based task for the participants are attested to in an automated manner by an authorized entity, such as an administrator, teacher/leader, etc.

So, the assessment defines in a computer-readable storage medium via the educational service: an educational subject area, a proficiency-based task to be given including content of the education subject area, procedures that are permissible for the proficiency-based task, mediums or mechanisms in which the proficiency-based task can be given, and ratings or scores that are to be assigned or given based on results of the proficiency-based task.

It is noted that each entity discussed herein includes an electronically identifiable identity (as discussed above). Each of which can be verified and authenticated at various points in the processing of the education service to ensure credibility and authenticity.

So, according to an embodiment, at 111, the education service validates the assessment in response to a digital signature and/or digital certification associated with the authorizing entity. In other words, the assessment is signed or electronically associated via a digital certificate with an identity assigned to the authorizing entity. This permits the education service to automatically authenticate the assessment and thereby distinguish it from false assessments or feigned assessments. In some cases, the education service enlists or consults in an automated, dynamic, and real-time fashion with an identity service to assist in verifying the assessment and/or the authorizing entity.

At 120, the education service configures the assessment in response to stipulations received with the proficiency-based task. At least some of the stipulations identify rewards/artifacts that are to be given to participants according to the participants' proficiency as measured by the proficiency-based task included with the assessment. The rewards are subsequently used in an automated and dynamic fashion during the performance of network-based games. These games are associated with educational competitions between two or more virtual communities that form teams for the game competitions. It is noted that game competitions can also include other proficiency-based tasks that the participants are to engage in with one another.

In some cases, the stipulations represent non-modifiable information assigned to the proficiency-based task defined within the assessment, such as a type of proficiency-based activity or evaluation, level of difficulty assigned to the proficiency-based task, whether the proficiency-based task is recognized by certain agencies and if so which agencies, etc. The stipulations may also define what types and amounts of rewards are to be given for certain levels of performance on the proficiency-based task. Also, the stipulations may indicate whether the rewards are convertible to other types of artifacts or rewards for network-based games that may not recognize the rewards provided with the proficiency-based task. Examples of rewards and artifacts are provided in greater detail below with reference to the FIG. 5.

According to an embodiment, at 121, the education service manages a profile for each of the participants. So, each participant can include a profile that includes such information as statistics for proficiency-based tasks taken by a participant, rewards/artifacts acquired and owned by a participant, true identity of a participant, etc. A participant can also be an administrator or a teacher/leader that monitors a proficiency-based task while another participant or participants are electronically taking the proficiency-based task or that evaluates results of a proficiency-based task after a proficiency-based task is taken.

In another situation, at 122, the education service manages multiple personas for one or more of the participants. That is, each participant can assume multiple different identities while taking any particular proficiency-based task. For example, one participant may be an honors student in one proficiency-based task context and not be in another context. Similarly, one participant may be a licensed professional for one proficiency-based task and not in another proficiency-based task context.

Continuing with the embodiment at 122 and at 123, the education service alters the rewards assigned to a number of the personas in response to pre-defined activities completed by those participants and as electronically verified or vouched for by either the authorized entity or another authorized entity or perhaps even the profile of those particular participants. For example, a student may have taken extra credit in a course, performed advanced lab work, or completed homework assignments that warrant added rewards that are in addition to what may be granted based strictly on a score achieved by these participants when taking the proficiency-based task.

In still another case, at 124, the education service permits some of the rewards to be converted to a monetary context for electronic redemption of merchandise and/or for play time on the network-based game. So, participants might be able to electronically redeem rewards for monetary values that can be used to buy spirit wear, other products, or even services. Similarly, the monetary values can be used to compete in network-based games within virtual communities that the participants belong to. Monetary values can also be used to redeem virtual items in a virtual world or game.

According to an embodiment, at 125, the education service permits some of the rewards to be converted to artifacts or special abilities that are capable of being used during play of the network-based game. More details and examples of the rewards, artifacts and their usages are provided in greater detail below with reference to the FIG. 5. It is noted that “artifacts” can include actual real-world items such as merchandise listed above and can include virtual items that are purchased with money or redeemed for with rewards. Some virtual items may include items used in a virtual reality, such as cars, houses, virtual jewelry, etc. So, the artifacts can be physical real world items as well as virtual world items.

At 130, the education service administers the assessment (having the proficiency-based task) to the participants in response to policy that is enforced during administration of the assessment. This occurs in an automated and dynamic fashion on one or more processors that are specifically configured to process the education service. It is noted that the assessment can be manually administered as discussed above and when this occurs the processing at 130 receives results for participants in an automated manner from a particular authorized entity, such as the administrator of the proficiency-based task, a teacher/leader, etc.

According to an embodiment, at 140, the education service enforces identity-based restrictions against the assessment, the authorizing entity, the virtual communities, and the participants. Again, this can be achieved in some instances via one or more identity services, such as the identity services discussed and incorporated by reference above, and which are modified to provide the identities discussed herein.

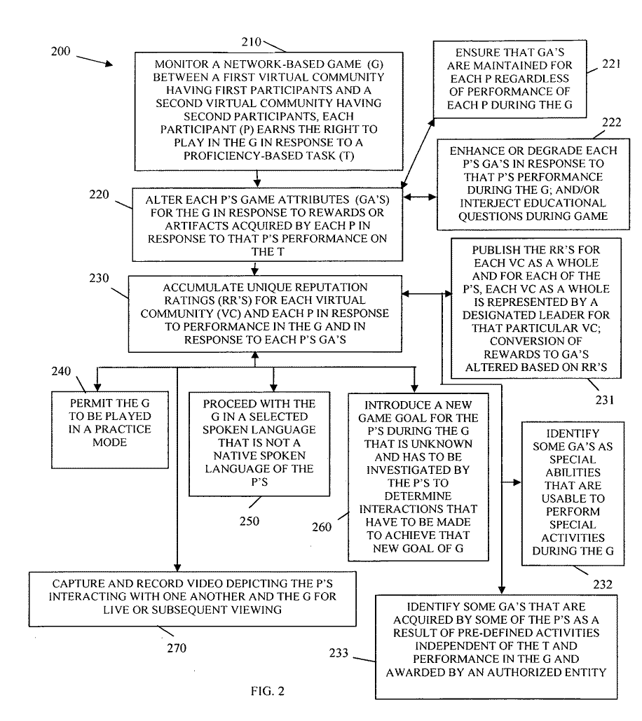

The education service provides the initial processing context for initially establishing and administering assessments having proficiency-based tasks and for uniformly and fairly awarding rewards and artifacts based on results of the proficiency-based tasks. Usage of these rewards and artifacts during network-based games (or proficiency-based tasks) associated with educational competitions between virtual communities is discussed below with reference to the FIG. 2.

FIG. 2 is a diagram of another method 200 for collaborative and competitive education, according to an example embodiment. The method 200 (hereinafter “collaborative and competitive education service” is implemented in a machine-accessible and computer-readable storage medium as instructions that execute on a processor and that is operational over a network. The processor is specifically configured to process the collaborative and competitive education service. Furthermore, the network may be wired, wireless, or a combination of wired and wireless.

At 210, the collaborative and competitive education service monitors a network-based game between a first virtual community and a second virtual community. The first virtual community has first participants and the second virtual community includes second participants. Each participant earns the right to play the game (or pays monetary rewards to play the game), which in some instances is in response to performance on one or more proficiency-based tasks (as was discussed above with reference to the method 100 of the FIG. 1 and included within assessments).

The communities can be formed in a variety of manners, such as by classroom in a particular course, by professional association, by similarities matched in an automated fashion online, and others. Examples of some virtual communities that can be formed and the manner in which they can be formed are discussed below in greater detail with reference to the FIG. 5.

At 220, the collaborative and competitive education service alters each participants game attributes for the game in response to rewards or artifacts acquired by each of the participants. In some cases, the altering of the game attributes occurs in response to a particular participant's performance on a proficiency-based task. Some examples of this were presented above with reference to the FIG. 1 and some additional examples are provided below with reference to the FIG. 5.

According to an embodiment, at 221, the collaborative and competitive education service ensures that the game attributes are maintained for each participant regardless of performance of each participant during the game.

In another case, at 222, the collaborative and competitive education service enhances or degrades each participant's game attributes in response to that participant's performance during the game.

So, game attributes can remain unchanged during game play or can be improved or lessened as a result of game play.

The game attributes are features usable during the game, such as expenditures for various items that can be used during the game or artifacts that provide additional features during the game. Some attributes may even expose additional play levels within the game. Some additional examples of the artifacts for some network-based games are presented below with reference to the FIG. 5.

In another case, at 222, the collaborative and competitive educational service alters the game during play, such that educational questions are asked in the middle of the game. The game itself may (in an embodiment) have nothing to do with learning or education (although in some cases it can be a purely educational game), but educational questions are interjected into the game at configurable points to challenge the participants and to enforce learning. In some cases, these questions may entail calculations that are partially completed or not completed at all. Partially completed calculations may exist when a particular participant has reached a desired level of learning as evidenced through the game attributes possessed by that particular participant. The game can be intercollegiate contests between university teams where students (participants) are rewarded and recognized via the level achieved in the game and the game attributes produced.

At 230, the collaborative and competitive education service accumulates unique reputation ratings for each virtual community. The unique reputation ratings are accumulated in response to each participant's performance in the game and in response to each participant's game attributes.

In an embodiment, at 231, the collaborative and competitive education service publishes the reputation ratings for each virtual community and for each of the participants. In some cases, the virtual community as a whole may be represented by a persona or identity for a particular leader (teacher or administrator) of that particular virtual community. In another situation, the reputation rating of a leader for a virtual community is imputed to that leader based on performance of the virtual community as a whole. Similarly, the reputation ratings of the leaders can be ranked so as to identify what is believed to be the best leader relative to a particular network-based game.

In another case, at 231, the collaborative educational service can alter how rewards translate into the game attributes possessed by a participant based on a teacher or leader associated with that participant.

In other words, one student (participant) may receive X points for achieving a grade or score of Y from a particular teacher T. When that student participates in the game, the points are converted into game attributes G or artifacts, and a reputation rating of Z for the teacher T can influence how X is converted to G. So, G=nX where n is a factor based on Z. The more educationally demanding the teacher, the better Z becomes relative to an average reputation rating and n can be greater than 1, which makes G higher than what may be expected; whereas another teacher that is less educationally demanding might have a reputation Z that is lower than an average reputation rating and n can be less than 1, which makes G lower than what may be expected. An average reputation rating can occur when n equals 1.

In this manner, students are motivated to seek out more demanding teachers so as to acquire more game attributes or artifacts for use during game play. This situation also engenders greater competition amongst the teachers to be better at their instruction for purposes of achieving higher reputation ratings. The entire scheme becomes a competition for the entire educational structure. Students and teachers are rewarded and all recognized within their virtual communities (via the reputation ratings and game attributes (rewards or artifacts)), while at the same time the participants are doing something that is fun (learning) and are being recognized for skills that might not normally be recognized in our society that to a large extent recognizes predominantly sport-based and entertainment-based values.

In addition to the individual teacher and student reputation ratings, entire virtual communities can have a reputation rating. Being associated with a highly regarded virtual community can result in immediate recognition on vitas of students or teachers. So, students and teachers may actively promote their associations with highly regarded and recognized virtual communities. Statistics associated with how and to what extent a participant performs within a virtual community can be gathered and available for usage by the participant. For example, actively scoring the highest in game X against virtual community Y (highly regarded) might be a statistic that participant Z wants to publicize. Some statistics may be subject to security or privacy restrictions that the owner of those statistics can control the dissemination and access to over the network.

In another situation, at 232, the collaborative and competitive education service identifies some game attributes as special abilities that are usable to perform special and unique abilities or activities during the network-based game play.

In yet another case, at 233, the collaborative and competitive education service identifies some game attributes that are acquired by some of the participants as a result of predefined activities that are independent of the proficiency-based task performance and independent of performance in the network-based game. These are awarded by an authorized entity and may be identified in a profile associated with particular participants. Examples of this were discussed above with reference to the FIG. 1 and are further provided with reference to the FIG. 5, described in detail below.

According to an embodiment, at 240, the collaborative and competitive education service permits the game to be played in practice mode. During practice mode, the rewards or artifacts are unaltered.

In another situation, at 250, the collaborative and competitive education service proceeds with the game in a selected spoken language that may or may not be a native or spoken language of the participants. This can be useful when the game is associated with mastery of a spoken foreign language.

In yet another case, at 260, the collaborative and competitive education service introduces a new game goal for the participants to actively attempt to discover during game play. This new game goal is unknown initially to the participants and has to be investigated during game play via game interactions and performance to achieve and identify the new game goal.

In still another situation, at 270, the collaborative and competitive education service captures and records video depicting the participants within the virtual communities in their physical settings with one another as they play the game. This can be used for live or subsequent broadcast of the video. In some cases, the video is not a camera but is a recordation of the game play that can be played back and studied at a later time to discover what went wrong and how to improve future game performance. So, in the context of 270 a “video” includes capturing of moving images, which can include physical recordation of activities of game participants or which can include digital recordation of images that are being transformed in a virtual reality game.

Students are generally less enthusiastic about education than they are about electronic games. So, the collaborative and competitive education service makes education a game that interests the students and can thereby create motivation for improving student or participant learning and for competing in manners that the students naturally want to partake in. Such scenarios are likely to even increase (unknowingly) educational pursuits of students who otherwise fear and do not like education or who feel they are poor performers in education. These techniques also provide a level and fair playing field for the competitors (students and teachers) and are done in an automated and dynamic manner over a network, such as an Internet Cloud (EdITC).

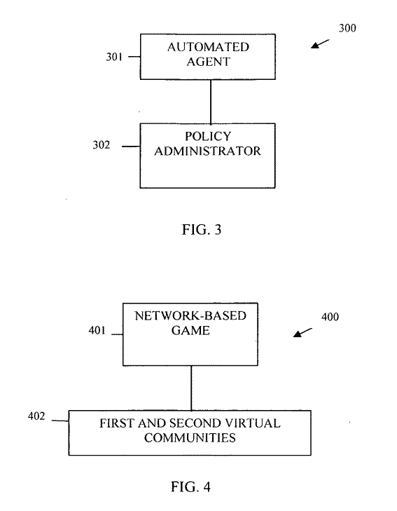

FIG. 3 is a diagram of a collaborative and competitive education system 300, according to an example embodiment. The collaborative and competitive education system 300 is implemented in a machine-accessible and computer-readable storage medium as instructions that execute one or more processors (multiprocessor) and that is operational over a network. The one or more processors are specifically configured to process the components of the collaborative and competitive education system 300. Moreover, the network may be wired, wireless, or a combination of wired and wireless. In an embodiment, the collaborative and competitive education system 300 implements, among other things, the education service and the collaborative and competitive education service represented by the methods 100 and 200 of the FIGS. 1 and 2, respectively.

The collaborative and competitive education system 300 includes an automated agent 301 and a policy administrator 302. Each of these will now be discussed in turn.

The automated agent 301 is implemented in a computer-readable storage medium and executes on a processor that is specifically configured for processing the automated agent 301. Example aspects of the automated agent 301 were presented in detail above with reference to the method 100 of the FIG. 1.

The automated agent 301 constructs a proficiency-based task (such as an electronic examination (other proficiency-based tasks were discussed above with reference to the method 100 of the FIG. 1)) as directed over the network by an authorized entity. This direction includes stipulations (as discussed above with reference to the method 100 of the FIG. 1) for the examination. The direction also includes policy (as referenced above with the method 100 of the FIG. 1).

According to an embodiment, an authorized entity provides a pool of electronic questions to the automated agent 301. The automated agent 301 uses the pool of questions to randomly select a predetermined (which may be defined in the policy) number of those questions to dynamically construct the electronic examination.

In another embodiment, the automated agent 301 provides profiles and personas for each of the participants that the policy administrator 302 uses to distribute the rewards. The profiles and personas were discussed above with reference to the method 100 of the FIG. 1 and as is further discussed with reference to the FIG. 5, discussed in detail below.

The policy administrator 302 is implemented in a computer-readable storage medium and executes on a different processor of the network or in some cases the same processor as the automated agent 301. The processor used is specifically configured to process the policy administrator 302. Example aspects associated with the policy administrator 302 were presented in detail above with reference to the method 100 of the FIG. 1.

The policy administrator 302 grants rewards to the participants in response to performance on the electronic examination and in accordance with the policy and enforcement of that policy. These rewards are usable to play network-based games or are usable to enhance play of those network-based games. Enhanced game play can include artifacts that are real world or virtual world based, as was discussed above. The network-based games are played among two or more virtual communities over a network, such as the Internet via EdITC.

According to an embodiment, the policy administrator 302 consults an identity service to authorize and enforce identity-based restrictions against the automated agent 301, the authorized entity, the examination, the participants, the network-based games, the rewards, and/or the virtual communities. Some identity services that can be modified to supply these identity and authentication services were presented and incorporated by reference above.

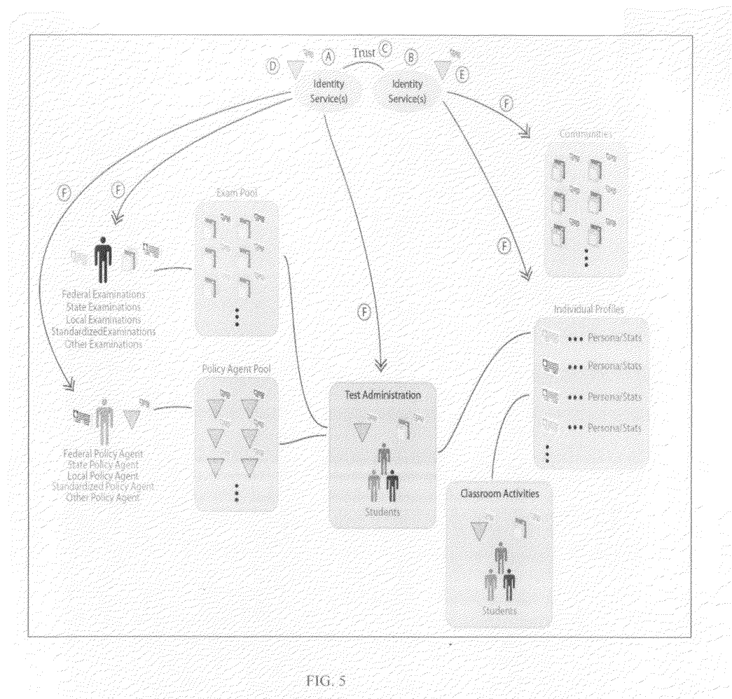

FIG. 4 is a diagram of another collaborative and competitive education system 400, according to an example embodiment. The collaborative and competitive education system 400 is implemented in a machine-accessible and computer-readable storage medium as instructions that execute on one or more processors (multiprocessor) and that is accessed and processed over a network. The one or more processors are specifically configured to process components of the collaborative and competitive education system 400. Furthermore, the network may be wired, wireless, or a combination of wired and wireless. The collaborative and competitive education system 400 performs the processing, among other things, as depicted above with reference to the methods 100 and 200 of the FIGS. 1 and 2, respectively, and with respect to the system 300 of the FIG. 3.

The collaborative and competitive education system 400 includes a network-based game 401 and first and second virtual communities 402. Each of these components and their interactions with one another will now be discussed in turn.

The network-based game 401 is implemented in a computer-readable storage medium and executes on a processor specifically configured to process the network-based game 401. Example aspects of some network games are provided above with reference to the FIGS. 1c5 and are further provided below with reference to the FIG. 5.

The network-based game 401 includes first participants for a first virtual community 402 and second participants for a second virtual community 402. Each participant includes game attributes that are defined based on performance on one or more previously administered proficiency-based tasks. The game attributes alter (improve or make harder) play of the network-based game 401.

In an embodiment, a reputation is maintained for each of the participants and each of the virtual communities 402.

In another case, policy is dynamically enforced in real-time to determine whether the game attributes are expended, maintained, enhanced, or degraded in response to performance in the network-based game 401.

The first and second virtual communities 402 are implemented in a computer-readable storage medium and execute the network-based game 401 over a network, such as the Internet via EdITC.

It is noted that the processors that are specifically configured to process the components of the methods and systems discussed herein can be configured in a dynamic and real-time fashion over the Internet.

An example architecture is now presented along with some example scenarios for the various embodiments presented herein and above.

FIG. 5 is an example architecture for collaborative and competitive education. The architecture can be used to implement the methods 100 and 200 of the FIGS. 1 and 2, respectively, and the systems 300 and 400 of the FIGS. 3 and 4, respectively. It is to be understood that the processing and example illustrations presented with FIG. 5 are one example implementation of the invention and that others are foreseeable and fall within the scope of the embodiments presented herein.

Various embodiments of the invention can be illustrated in terms of a computerized fantasy game (e.g., Ultima, World of Warcraft) but other types of computerized games interactions can be profitably used to target different age groups, genders, religious preferences, etc. For example, a car racing motif can be used with artifacts (virtual-world based) being engines, superchargers, struts, tires, etc. rather than swords, armor, siege weapons, etc. In another case, fantasy sports teams and games can be used with artifacts being more trades or better players for the fantasy league game play.

Initially, there are Identity Service(s) (“A” and “B”) that provide identity services as described below. Examples of identity services that can be modified to provide the identity services as described herein were incorporated by reference herein and above.

In an embodiment, “A” and “B” have a trust relationship “C” with one another. Likewise, “D” and “E” represents policy enforcement when an identity is crafted for any given person, agent, document, etc. While the diagram shows the policy enforcement mechanism as an inverted triangle (traditionally representing a virtual machine), other policy mechanisms are also accepted for the crafting of an identity.

The double-headed arrow labeled “F” multiple times represents the need for identity in some aspects of the invention. Any reference to identity is in regard to “F” from “A” or “B.”

Specific to an embodiment of the invention is the creation of examinations or proficiency-based tasks (as discussed above) by Federal, State, Local, or Standardized examination preparation personnel. Each person or automation agent (e.g., pools of examination questions could be used by an automation agent to randomly select questions to be specified as an examination) can have an identity that has either entitlements or attestations that indicate that the person or agent has the rights and permissions necessary to prepare an examination. Also, each examination is associated with an identity which provides non-modifiable information concerning the examination. This information may include stipulations concerning the type of examination, the influence of the examination (e.g., an ACT or SAT examination would have an influence that would be nation-wide and could be used by institutions of higher education to fulfill admission criteria whereas a state examination may have an influence that is specific to a state (e.g., Utah) to provide an indication of compliance with state regulations). Also there can be stipulations concerning the reward for having taken the examination and/or rewards for scoring various levels from having taken the examination. For example, so many “gold coins” can be granted for taking the test and additional “gold coins” can be granted for getting certain grades from having taken the examination. As well, the “gold coins” can be marked with an influence or monetary context so that the “gold coins” can just be used in certain games or to buy certain items. In an embodiment, items purchased with gold coins in one monetary context can not be used in games restricting the use of such gold coins. Likewise, an exchange rate can be specified in a game where gold coins from one monetary context can be exchanged for gold coins in a different monetary context. The validity of a declared monetary context is governed by the examination preparer's identity. In an embodiment, rewards can also include artifacts such as armor, weapons, letters of introduction, etc. where such artifacts can also have a context of use and can be governed similar to the preceding discussion.

Embodiments also provide for “Policy Agents” that are associated with one or more examinations. In an embodiment, examinations are conducted in the cloud (EdITC) and the Policy Agent provides policy enforcement for the associated examinations. Again, Federal, State, etc. personnel or agents have identities that provide the attestations or entitlements to allow the personnel or agent to configure the Policy Agent. When an examination is administered or when rewards/artifacts are granted, the Policy Agent can arbitrate the dispensing of such rewards/artifacts. In this way a standardized mechanism for providing exchange rates, granting of rewards/artifacts, etc. is provided so that all are treated the same. Since the invention provides for communities to exist virtually or “in the cloud” it is proper that policy is controlled so that a level playing field is provided. Again, the Policy Agents are shown as virtual machines with associated identities. This is one embodiment, since the Policy Agent can be instantiated without changes during test administration or reward/artifact granting.

In both cases for examinations and Policy Agents, the identity associated with such has a limiting time factor that determines when the validity of the examination or Policy Agent must be re-attested if such is to continue to be used.

Students are provided with Individual Profiles containing the information associated with the individual including identity, personas, statistics by persona, overall statistics, rewards/artifacts per persona, etc. It is noted that an individual may be a student, teacher, administrator, etc.; whatever is pertinent to the proper running of the game. Also, each individual can have multiple personas, e.g., a gifted student may have a persona as a member of a community that represents fellow students while also having a persona allowing higher levels of play in the game because of “educational enrichment” (e.g., a student may be participating as a high school student and a college student under different personas). Also, a teacher can have personas that allow play in the game or moderation in the game (e.g., police officer).

Communities are formed to associate individuals of like interest or educational groupings (e.g., the virtual or cloud classroom). An embodiment provides for the formation of communities that include personas that may span the globe without regard to geographic location or the opposite. In an embodiment, communities may be formed ad hoc to allow specialized play or learning.

Tests or examinations are administered to an individual or persona or community as constrained by the associated Policy Agent and rewards/artifacts are granted to the persona by the Policy Agent. Such grants are associated with a non-modifiable identity that specifies the entitlements, monetary context, etc. of the grant. When the grant is used during game play its use may modify the persona to include new rewards/artifacts and a notation made to specify the change in the original reward/artifact. This may be done by encapsulating the original reward/artifact in a new reward/artifact signed by the changing agent, or global notation of the change to the reward/artifact may be made and the original reward/artifact changed later. In any case, use of rewards and artifacts may cause changes that are attested to (e.g., digitally signed) so that rewards and artifacts can not be reused inappropriately.

Classroom activities can also provide changes to a persona or the granting of rewards/artifacts. Consider that a Federal, State, Standardized, etc. agency provides one or more rewards/artifacts to an individual (e.g., a school or community principal or a community teacher). The disbursement of such rewards/artifacts is up to the discretion of the school principal or teacher (types of resources as discussed above) or such may delegate the disbursement to others that have particular persona entitlements (e.g., an entitlement that allows the disbursement of rewards/artifacts). In this way, local control of sought-after rewards/artifacts can be used to enrich the learning environment of a community via classroom activities. In an embodiment, the leaders of communities (e.g., a teacher) may accrue a reputation for conducting learning activities such that a higher-than-expected ratio of such extra rewards/artifacts is assigned to personas (students) in communities handled by the teacher.

Thus, embodiments provide for the creation of examinations, Policy Agents, monetary context, artifact context, disbursement policy, administration policy, creation of communities and the development of personas all in preparation for playing the game. In one case of the invention, the game is conducted via a computerized gaming mechanism. In another embodiment this computerized gaming mechanism is distributed and virtual and available over the Internet.

Game play now proceeds with certain innovations provided by the invention. The invention provides for games being conducted among select communities (e.g., among classes, schools, clubs, etc.). In an embodiment personas can not lose any rewards/artifacts as a result of a game. In an embodiment, personas can lose either rewards or artifacts. In an embodiment, artifacts can be damaged or discharged or used up during play but may be fixed, charged, or replenished either during a game or after or as a result of the effects of other rewards/artifacts. Reputations are aggregated and published for personas and/or communities. In an embodiment, a community leader (e.g., teacher) may also have a reputation that is an aggregation of play statistics from the play of communities governed by the community leader.

In an embodiment, ad hoc play may be conducted and can be governed by rewards accrued from other activities (e.g., classroom activities).

In an embodiment, practice play is allowed according to some policy, or governed by a Policy Agent to allow a community to practice strategies and/or tactics. In an embodiment, rewards and artifacts are not used up during practice.

In an embodiment, certain personas can have special abilities that have been granted as a result of prior activities. An example can be the ability to calculate the trajectory of a projectile from a siege engine. While the setup of a siege engine may be done in real life by using a programmable calculator, if the persona does not have a specialized ability that provides for such calculations, the game can automatically inject errors into calculations provided by such. Thus, a persona that passed a trigonometry or geometry test with a very high score can gradually increase this specialized capability whereas others can not unless they also learn the material and passed the tests. This structure provides students that may not be good in traditional sports-associated activities the ability to become valuable in a game setting where they may be the coveted “outside shooter.” Other specialized abilities can be defined for things like diplomacy, strategies, negotiations, etc. The end goal of such abilities is to encourage students to study, learn, and demonstrate learning via examination to hone abilities that can be valuable in the game. Note that “demonstrate learning via examination” can be performed a number of ways. It has already been discussed, herein and above, that proficiency-based tasks, Policy Agents, and administration mechanisms can be used. But, it is also known that some students do not test well in traditional examination contexts. To this end, other examination methods can be employed as long as they are governed by policy and their methods approved by examination personnel with sufficient rights or attested permission.

It is well to note that the invention provides for practice, special abilities, rewards, and/or artifacts. Such assets are accrued directly from participation in learning activities and the demonstration of proficiency (e.g., geometry as discussed above).

In an embodiment, some forms of game play can be used to show proficiency and can take the place of examinations.

In an embodiment, communities can be formed from students of home schooling to form larger social groups that allow better competition and collaboration in the game

In an embodiment, certain games can be conducted in different languages and proficiency in the language can provide rewards/artifacts during play (e.g., depth of language usage provides more rewards).

In an embodiment, each period of time can introduce a new “game goal” that is unknown and is to be investigated by players to determine the interactions necessary to achieve the goal (e.g., introduce a new island with a new race to interact with—using the fantasy motif).

In an embodiment, virtual cameras can be provided and managed to record game play so that an audience (in the cloud (EdITC) or out) can watch and record it for later use. This can allow contests on many levels (national, regional, local, etc.) to be viewed by interested audiences.

It is noted that in some embodiments of the invention, in additional to collaborative and competitive educational competitions that some participants can compete strictly against themselves to acquire an individual score that can then be compared against others that similarly compete. So, when one plays a game of solitary and acquires a certain score that score can be uploaded and compared to others that have played solitary. Similarly, when one throws a disk in track that person is competing technically against him/her for a certain distance. Thus, it is to be understood that in some embodiments the invention can be practiced such that the competition is achieved via a single participant that acquires a score or rating that can then subsequently be compared to others. Accordingly, collaboration can be practiced via teams of virtual communities as presented herein and above and competitions can be given based on individual performances and results and subsequently compared in a collaborative manner to individual scores of others in one or more virtual communities.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method implemented in a computer-readable storage medium that is executed by a processor to perform the method, comprising:
receiving an assessment from an authorizing entity that administers a proficiency-based task included in the assessment;
configuring the assessment in response to stipulations received with the assessment, wherein at least some stipulations identify rewards that are to be given to participants that take the proficiency-based task of the assessment, and wherein the rewards are used in the performance of network-based games among virtual communities; and
administering the assessment to the participants in response to policy enforced during the assessment.

2. The method of claim 1 further comprising, enforcing identity-based restrictions against the assessment, the authorizing entity, the virtual communities, and the participants.

3. The method of claim 1, wherein receiving further includes validating the assessment in response to a digital signature and/or digital certificate associated with the authorizing entity.

4. The method of claim 1, wherein configuring further includes managing a profile for each of the participants.

5. The method of claim 1, wherein configuring further includes managing multiple electronic personas for one or more of the participants.

6. The method of claim 5, wherein managing further includes altering the rewards assigned to a number of the personas in response to pre-defined activities completed by those personas and verified by the authorized entity or another authorized entity.

7. The method of claim 1, wherein configuring further includes permitting some of the rewards to be converted to a monetary context and/or for redemption of merchandise or for play time on the network-based game.

8. The method of claim 1, wherein configuring further includes permitting some of the rewards to be converted to artifacts or special abilities that are used during play of the network-based game.

9. A method implemented in a computer-readable storage medium that is executed by a processor to perform the method, comprising:
monitoring a network-based game among a first virtual community having first participants and a second virtual community having second participants;
altering each participant's game attributes for the network-based game in response to rewards or artifacts acquired by each participant; and
accumulating unique reputation ratings for each community and each participant in response to performance in the network-based game and in response to each participant's game attributes.

10. The method of claim 9 further comprising, permitting the network-based game to be played in a practice mode.

11. The method of claim 9 further comprising, proceeding with the network-based game in a selected spoken language.

12. The method of claim 9 further comprising, introducing a new game goal for the participants during the network-based game that is unknown and has to be investigated by the participants to determine interactions that have to be made to achieve that new goal of the network-based game.

13. The method of claim 9 further comprising, capturing and recording video depicting the participants interacting with one another and the network-based game for live or subsequent viewing.

14. The method of claim 9, wherein monitoring further includes permitting each participant to earn the right to play in the network-based game in response to a proficiency-based task.

15. The method of claim 14, wherein altering further includes, altering each participant's game attributes in response to that participant's performance on the proficiency-based task.

16. The method of claim 9, wherein altering further includes ensuring that game attributes are maintained for each participant regardless of the performance of each participant during the network-based game.

17. The method of claim 9, wherein altering further includes enhancing or decreasing each participant's game attributes in response to that participant's performance during the network-based game.

18. The method of claim 9, wherein altering further includes integrating or interjecting educational questions during game play and wherein, based on the game attributes some of the educational questions are partially completed.

19. The method of claim 9, wherein accumulating further includes publishing the reputation ratings for each community as a whole and for each of the participants, and wherein each community as a whole or as a part is represented by a designated leader for that particular community.

20. The method of claim 9, wherein accumulating further includes identifying some game attributes as special abilities that are usable to perform special activities during the network-based game.

21. The method of claim 9, wherein accumulating further includes identifying some game attributes that are acquired by some of the participants as a result of pre-defined activities independent of performance on a proficiency-based task and independent of performance in the network-based game and awarded by an authorized entity.

22. The method of claim 9, wherein accumulating further includes enhancing or degrading each participant's game attributes in response to a reputation rating of a teacher for that participant.

23. A multiprocessor-implemented system, comprising:
an automated agent implemented in a computer-readable medium and to execute on a processor configured for processing the automated agent; and
a policy administrator implemented in a computer-readable medium and to execute on a processor configured for processing the policy administrator;
wherein the automated agent constructs an examination as directed by an authorized entity along with stipulations for the examination and policy, and wherein the automated agent administers the examination to participants in response to the stipulations and by enforcing the policy, and wherein during the examination rewards are granted in response to the policy enforcement, the rewards associated with the participants based on their performance on the examination and usable in network-based games between virtual communities.

24. The system of claim 23, wherein the policy administrator consults an identity service to authorize and enforce identity-based restrictions against the automated agent, the authorized entity, the examination, the participants, the network-based games, the rewards, and the virtual communities.

25. The system of claim 23, wherein the automated agent is provided a pool of electronic questions from the authorized entity that the automated agent uses to randomly select a predetermined number of those questions from that pool to construct the examination.

26. The system of claim 23, wherein the automated agent provides profiles and personas for each of the participants that the policy administrator uses to direct distribution of the rewards.

27. A multiprocessor-implemented system, comprising:
a network-based game implemented in a computer-readable medium and to execute on a processor configured to process the network-based game; and
first and second virtual communities implemented in a computer-readable medium and to execute the network-based game over a network;
wherein the network-based game includes first participants for the first virtual community and second participants for the second virtual community, and wherein each participant includes game attributes that are defined based on performance on one or more previously administered proficiency-based tasks, and wherein the game attributes alter play of the network-based game.

28. The system of claim 27, wherein a reputation is maintained for each of the participants and each of the virtual communities.

29. The system of claim 27, wherein policy is enforced to determine whether the game attributes are expended, maintained, degraded, or enhanced in response to performance in the network-based game.
